(19) United States
(12) Patent Application Publication
(10) Pub. No.: US 2017/0311221 A1
(43) Pub. Date: Oct. 26, 2017

(54) MOBILITY MANAGEMENT

(71) Applicant: VODAFONE IP LICENSING LIMITED, Newbury, Berkshire (GB)

(72) Inventor: Chris PUDNEY, London (GB)

(21) Appl. No.: 15/526,257

(22) PCT Filed: Nov. 12, 2015
(86) PCT No.: PCT/GB2015/053437

§ 371 Date: May 11, 2017

(30) Foreign Application Priority Data
Nov. 12, 2014 (GB) 1420140.4

(51) Int. Cl. H04W 36/30; H04W 36/00; H04W 36/24; H04W 8/26; H04W 8/12

(52) U.S. Cl. CPC H04W 36/30; H04W 36/0083; H04W 36/24; H04W 8/26; H04W 8/12; H04W 36/0011

(57) ABSTRACT

The present disclosure relates to methods, apparatus and systems for paging of a terminal. The disclosure provides a method for allocating a paging area for the terminal (130) in a cellular network comprising determining a coverage level for the terminal (130) in a cell in the cellular network, identifying a paging area corresponding to the determined coverage level for the terminal (130); and allocating the identified paging area to the terminal (130).

### TECHNICAL FIELD

The present disclosure relates to a method, apparatus and a system for allocating a paging area for a terminal in a cellular network. The present disclosure further relates to a method, apparatus and a system for identifying a paging area. The present disclosure further relates to a method, apparatus and a system for communicating a paging message to a terminal. The present disclosure also relates to a method, apparatus and system for communicating a paging message to a terminal in the most recent cell that the terminal was known to be in.

### BACKGROUND

1 Introduction

This document looks at how the current Mobility Management concepts (either Gb or S1) can be adapted to efficiently serve Cellular IoT (either “clean slate” or “evolved GSM”).

While many M2M devices may be stationary, a proportion will be mobile or nomadic. Even if that proportion is small, our vision for vast numbers of CIoT devices (e.g. 40 per household) will mean that the actual number of moving devices will be large. In addition, the act of movement is one that is likely to lead to some M2M devices being tracked.

Current GERAN 1 studies have shown ‘repetition’ as one mechanism to extend the coverage for the channel carrying System Information. However the content of the System Information is relatively static while the information on the Paging Channel is completely dynamic—and even more dynamic if paging messages attempt to page more than one mobile at a time!
→ Paging in extended coverage will be extremely resource consuming.

Having small paging areas is not a sufficient solution—it will just lead to large amounts of signalling load as devices re-register when they move out of the current paging area.

Section 2 of this document provides an overview of mobility management in the access network in current 3GPP systems. Subsequent sections describe aspects and components that can be combined together to provide an overall mobility management solution for CIot.

2 How Does Routing Area/Tracking Area Updating Work?

The following is a summary of how RA updating and paging works on the UE side of the SGSN. TA (and LA) updating is broadly similar.

This summary is provided so that any misunderstandings can be resolved early in the CIot work.

The overall processes are specified in detail in TSs 23.060 and 23.401 and the individual components of this behaviour are precisely specified for GERAN in TSs 24.008, 48.008 and 48.018; for UTRAN in TSs 24.008 and 25.413; and for E-UTRAN in TSs 24.301, 36.300 and 36.413.

Firstly there is some pre-configuration of the network:
i) Each cell is configured to broadcast one RAI.
ii) The SGSN is configured to know which RAIs are in use on each BSS it is connected to (one RAI may be used by cells on different BSSs)

When the device moves into a new registration area:
a) UE sees that it has left its old paging area
b) The UE sends an RA Update Request to the SGSN via the BSS. This RAU Request contains the device's globally unique temporary ID (i.e. the OLD P-TMSI and OLD RAI). The RAU Request does not contain the new cell's RAI.
c) The BSS sends the RAU Request to the SGSN as one IE in a Gb interface message. The BSS inserts the new Cell ID and the new cell's RAI into that Gb interface message.
d) The SGSN sends an RA Update Accept to the UE containing the RAI that the RAN added in step c.
e) The SGSN stores the RAI assigned to the UE in its database (its “VLR”)

Then when a Mobile Terminating event arrives at the SGSN:
1) Mobile terminating data/SMS arrives in SGSN
2) SGSN retrieves UE's current RAI from SGSN's “VLR”
3) SGSN looks up which BSSs have cells in that RAI (using the configuration data entered in step ii).
4) SGSN sends one Gb paging message (TMSI, RAI) to each of those BSSs.
5) The BSS causes its cells which are in that RAI to page that TMSI.
6) The UE responds to the SGSN by signalling via the cell that it is camped on.
7) The MT data/SMS is sent to the UE via the new cell.

The above processes should be borne in mind while reading the rest of this document.

### SUMMARY

In an aspect of this disclosure, there is provided a method for allocating a paging area (such as a location area, routing area or tracking area) for a terminal (such as a user equipment device, UE, or a machine-to-machine, M2M, device) in a cellular network (or radio access network), the method comprising the steps of: determining a coverage level for the terminal in a cell in the cellular network (or radio access network); identifying a paging area corresponding to the determined coverage level for the terminal; and allocating the identified paging area to the terminal.

This aspect of the disclosure corresponds to the specific example identified in section 6 (Proposals 6 and 7) of the description below.

A radio access network entity or base station (for example, a base station system, e NodeB, or NodeB) may support two or more (for example, three) paging areas (for example, routing areas) per cell.

The radio access network entity or base station may determine a coverage level for the terminal on the cell (for example, normal, poor, extended, or any other coverage level). This may be determined from a terminal transmission that is received (or otherwise obtained) at the radio access network entity or base station (such as an RA Update Request or Attach Request, or any other suitable form of transmission).

Each different coverage level may be associated at the base station with one of the paging areas of which the cell is a member (for example, the broadcast RAIs). The radio access network entity or base station may therefore match the coverage level to the corresponding paging area and allocate that paging area to the terminal.

The allocated paging area may be communicated to a core network entity (for example, an SGSN in GSM/GPRS architecture, or an MME in LTE architecture). The network entity may then allocate that paging area back to the terminal, for example by sending an RAU Accept message to the terminal.

Therefore, existing interface signalling can be used between the base station and network entity and an unmodified network entity can be used to assign paging areas corresponding to the correct coverage level.

The method may comprise receiving (or otherwise obtaining), at a radio access network entity or base station, a transmission from the terminal (for example, a paging area update request, such as an RA Update Request), wherein the step of determining the coverage level for the terminal in the cell is based at least in part on the received (or otherwise obtained) transmission.

Allocating the identified paging area to the terminal may comprise transmitting the allocated paging area to the core network (for example, to a Serving GPRS Support Node, SGSN, or a Mobility Management Entity, MME).

The method may further comprise transmitting a request that the core network constructs a paging area listing comprising a single paging area. This may find particular application in LTE architectures, whereby an additional parameter may be communicated from the radio access network entity or base station system to the core network (for example, an MME) to indicate that the page area list that the core network creates (for example, a TAI List) should be constrained to a single paging area (for example, a single TAI). In this way, logic is constructed to ensure that the core network entity does not add extra paging areas to the paging area list. Alternatively, rather than using an additional parameter in the communications, it may be achieved by a coding within the TAI.

The allocated paging area may be transmitted to the core network using GSM/GPRS standards and/or a GSM/GPRS architecture and/or GSM/GPRS protocols.

The core network may comprise a core network entity such as a Serving GPRS Support Node (SGSN) and the allocated paging area may be transmitted to the core network via a Gb interface. The allocated paging area may be transmitted to the core network via the Gb interface as at least part of a UL Unitdata message.

Alternatively, the allocated paging area may be transmitted to the core network using LTE standards and/or using an LTE architecture.

The core network may comprise a core network entity such as Mobility Management Entity (MME) and the allocated paging area may be transmitted to the core network via an S1 interface. The allocated paging area may be transmitted to the core network via the S1 interface as at least part of an MME message.

The paging area may comprise at least one of a location area, a routing area and/or a tracking area.

The coverage level for the terminal may comprise at least one of a normal coverage level, a poor coverage level, and/or an extended coverage level.

In a further aspect of the present disclosure, there is provided a radio access network entity or network entity (for example, a base station system, or e Node B, or Node B) configured to perform the above disclosed method.

The network entity may be a single entity (for example an e NodeB, or a Node B, or a base station system) or may be part of a single entity. Alternatively, its functionality may be divided between two or more different entities that may interface with one another in order to carry out the functionality described above. The two or more different entities may be co-located, or located in different geographic locations.

The network entity may be configured to broadcast a plurality of paging area identifiers per cell, such that the network entity is a member of a plurality of paging areas. The network entity may be configured to broadcast a plurality of paging area identifiers per cell such that a plurality of paging areas may be supported by the network entity so any one of a plurality of paging area identifiers may be broadcast to a terminal to instruct the terminal as to which paging area it should join for the cell in which it is camped.

In a further aspect of the present disclosure, there is provided a terminal (such as a UE or M2M device) configured to identify a paging area (for example, a location area, routing area or tracking area) in a cellular network (or radio access network) using at least a cell identifier.

For example, the terminal may be within a cell that is a member of a plurality of paging areas (for example, two, three, four or more paging areas). The plurality of paging areas may, for example, be routing areas. Each of the different routing areas may be identified by a routing area identifier (RAI). For example, a first RAI might identify a first routing area (for example, an RAI for the sector), a second RAI might identify a second routing area (for example, an RAI common across two or more sectors of a site) and a third RAI might identify a cluster of multiple sites (for example, 7 sites).

At least one of these paging areas may be uniquely identified by the terminal using at least a cell identifier, i.e. the terminal may create a unique identifier for a paging area using at least the cell identifier. For example, a radio access network entity or base station for a cell that is a member of a plurality of paging areas may broadcast the cell identifier and one or more further identifiers. The further identifiers may comprise at least one of a mobile country code (MCC), a mobile network code (MNC), a location area code (LAC), a location area identifier (LAI) and/or a routing area code (RAC). Each of the different plurality of paging areas may be uniquely identified using different combinations of these identifiers, wherein at least one of the paging areas is uniquely identified using at least the cell identifier.

By way of specific example only, the first paging area may be identified using the cell identifier combined with the MNC and MCC (also known in combination as the BCD) and the LAC (wherein MNC+MCC+LAC are otherwise known as the LAI). The second paging area may be identified using the LAI combined with the RAC. The third paging area may be identified using the cell identifier combined with the BCD and RAC.

In this way, it is not necessary to broadcast a different paging area code (for example, RAC) in order uniquely to identify each paging area. This reduces the amount of system information (SI) that needs to be broadcast while marinating the ability for one base station to be a member of multiple paging areas.

The terminal may be configured to: receive (or otherwise obtain) a cell identifier; and identify the paging area by determining a paging area identifier based at least in part on the cell identifier.

The paging area may be a routing area and the terminal may be configured to receive (or otherwise obtain) at least one of a mobile country code, a mobile network code, a location area code, a location area identifier and/or a routing area code; and determine the paging area identifier based at least in part on the cell identifier and at least one of the received (or otherwise obtained) mobile country code, a mobile network code, a location area code, a location area identifier and/or a routing area code.

The terminal may be further configured to modify at least part of the cell identifier; and determine the paging area identifier based at least in part on the modified cell identifier.

For example, a further paging area may be identified by modifying at least part of the cell identifier (such as changing the end of the cell identifier to a particular value, such as 00, or adding a particular value to the end of the cell identifier, such as 0110 etc) and using at least the modified cell identifier to identify a paging area. By way of specific example only, a fourth paging area may be identified by combined the BCD, the RAC and the modified cell identified. This may find particular application for identifying “the site”, wherein other paging areas indicate sectors within the site.

The terminal may be further configured to: check the identified paging area against a paging area list; and if the paging area list does not comprise the identified paging area, transmit a paging area update request.

For example, the terminals NAS may check the contents of a paging area list (for example, an RAI list) received (or otherwise obtained) in the most recent accept message (for example, RAU Accept message) against all of the identified paging areas. If there is a match, the terminal does not need to transmit a paging area (for example, RA) update message. If there is not a match, the terminal may need to transmit a paging area update request.

In a further aspect of the present disclosure, there is provided a radio access network entity or base station system for support of a cell that is a member of a plurality of paging areas, wherein at least one of the paging areas is identifiable using at least an identifier of the cell.

The radio access network entity or base station system may be configured to: broadcast the identifier of the cell; wherein at least one of the plurality of paging areas is uniquely identifiable using at least the identifier of the cell.

The radio access network entity or base station system may be further configured to broadcast at least one of a mobile country code, a mobile network code, a location area code, a location area identifier and/or a routing area code, wherein at least one of the plurality of paging areas is uniquely identifiable using the identifier of the cell and at least one of the mobile country code, the mobile network code, the location area code, the location area identifier and/or the routing area code.

At least one of the plurality of paging areas may be uniquely identifiable using at least the identifier of the cell and a combinations of at least one of mobile country code, mobile network code, location area code, location area identifier and/or routing area code. All of the other plurality of paging areas may also be uniquely identifiable using different combinations of at least one of the identifier of the cell, the mobile country code, the mobile network code, the location area code, the location area identifier and/or the routing area code.

In a further aspect of the present disclosure, there is provided a system comprising: a radio access network entity or base station for supporting a cell that is a member of a plurality of paging areas; and a terminal configured to identify at least one of the paging areas using at least an identifier of the cell.

The terminal may be configured to uniquely identify at least one of the paging areas using at least an identifier of the cell combined with at least one of a mobile country code, a mobile network code, a location area code, a location area identifier and/or a routing area code.

In a further aspect there is provided a method for identifying a first paging area of a plurality of paging areas of which a cell is a member, the method comprising identifying the first paging area using at least an identifier of the cell.

The first paging area may be identified using at least the identifier of the cell combined with at least one of a mobile country code, a mobile network code, a location area code, a location area identifier and/or a routing area code.

The method may further comprise identifying a second paging area using at least the identifier of the cell combined with at least one of a mobile country code, a mobile network code, a location area code, a location area identifier and/or a routing area code, wherein the combination used to identify the second paging area is different to the combination used to identify the first paging area.

In a further aspect of the present disclosure, there is provided a core network entity (for example, a Serving GPRS Support Node, SGSN, or a Mobility Management Entity, MME) for interfacing with a radio access network entity (for example, an e NodeB, or a Node B, or a base station system), the core network entity being configured to: communicate paging data to the radio access network entity, the paging data comprising a paging message to be broadcast to a terminal (for example, a user equipment device, UE, or a machine-to-machine, M2M, device); obtain (for example, receive) a positive confirmation that indicates that the paging message has been received by the terminal; and intermittently re-communicate (or retransmit) the paging data to the radio access network entity until a positive confirmation has been obtained.

The core network entity may obtain the positive confirmation by any suitable means, for example, retrieving it from a location such as a radio access network entity in the radio access network (or cellular network) (which may be the same entity that output the paging message for broadcast, or a different entity in the radio access network), or receiving it from the terminal by signalling via the cell that it is camped on.

Intermittently re-communicating the paging data may be periodically re-communicating the paging data, wherein periodic means at equal, or substantially equal, intervals of time (for example, every second, every 5 seconds, every 10 seconds, etc). Alternatively, intermittently re-communicating the paging data may be re-communicating the paging data at intervals of time, wherein the interval of time between each re-communication may be the same or different.

The core network entity is therefore configured to carry out repeated page transmission, or paging repetition, by intermittently re-communicating the paging data until a positive confirmation has been obtained.

The paging data may further comprise: a repetition number that is indicative of the number of times the paging message has been retransmitted (or communicated or recommunicated) to the radio access network (RAN) (or cellular network) without a positive confirmation having been obtained. The repetition number may, for example, indicate the number of times that the paging message has previously been communicated, or transmitted, to the radio access network (or cellular network). For example, if the paging message has previously been communicated to the radio access network (or cellular network) three times and it is now being communicated to the radio access network (or cellular network) for a fourth time, the repetition number would indicate three previous communications of the paging message. Alternatively, the repetition number may indicate the number of times the paging message has been communicated including the current communication of the paging message. For example, if the paging message has previously been communicated to the radio access network (or cellular network) five times and it is now being communicated to the radio access network (or cellular network) for a sixth time, the repetition number may indicate six communications of the paging message.

The repetition number may be indicative of the number of times the paging message has been communicated to any radio access network entity within the RAN or cellular network. For example, it may be the first time that the paging message has been communicated to a particular radio access network entity in the RAN, with the paging message having previously been communicated a number of times to at least one other radio access network entity in the RAN or cellular network. In this way, the repetition number may indicate the number of times the paging message should have been broadcast to the terminal by the RAN or cellular network, regardless of which radio access network entity performed the broadcasting. Alternatively, the repetition number may be indicative of the number of times the paging message has been communicated to the particular radio access network entity within the RAN.

At each communication/transmission or recommunication/retransmission of the paging message, the core network entity may communicate/transmit a plurality of paging messages to a plurality of radio access network entities, for example 100 paging messages at the same time to 100 radio access network entities. The repetition number counts the number of communication/transmission or recommunication/retransmission events, rather than the number of paging messages sent in each event.

The paging data may further comprise: an indication of the importance of the paging message. For example, it may indicate that it is of low importance, for example for a routine ping of a door sensor, or it may indicate that it is of a high importance, for example trying to track a stolen high value car. The indication of the importance may take any form that is suitable to communicate the level of importance to the radio access network entity.

The indication of the importance of the paging message may indicate the importance of the mobile terminated event to which the paging message relates.

The core network entity may be further configured to: if a positive confirmation is obtained, communicate a paging cancelation message to the radio access network entity. Any pending paging message(s) for the terminal, or repeated paging of the terminal, may be cancelled in this way.

The radio access network entity may be a plurality (for example, two or more, such as three, eight, fifteen, etc) of radio access network entities in a radio access network (or cellular network). Thus, the core network entity may communicate the paging data to a plurality of radio access network entities in the RAN.

The core network entity may be further configured to communicate the paging data to the radio access network entity using GSM/GPRS standards and/or GSM/GPRS architecture and/or GSM/GPRS protocols. The core network may comprise at least one Serving GPRS Support Node. The core network entity may be further configured to communicate the paging data to the radio access network entity via a Gb interface.

The core network entity may be further configured to communicate the paging data to the radio access network entity using LTE standards and/or LTE architecture. The core network entity may comprise at least one Mobility Management Entity (MME). The core network entity may be configured to communicate the paging data to the radio access network entity via an S1 interface.

In a further aspect, there is provided a core network entity (for example, a Serving GPRS Support Node, SGSN, or a Mobility Management Entity, MME) for interfacing with a radio access network entity (for example, an e NodeB, or a Node B, or a base station system), the core network entity comprising: a communication module configured to communicate paging data to the radio access network entity, the paging data comprising a paging message to be broadcast to a terminal (for example, a user equipment device, UE, or a machine-to-machine, M2M, device); and a confirmation module configured to obtain (for example, receive) a positive confirmation that indicates that the paging message has been received by the terminal, the communication module being further configured to intermittently re-communicate (or retransmit) the paging data to the radio access network entity until a positive confirmation has been obtained.

The present disclosure also provides a radio access network entity (for example, an e NodeB, or a Node B, or a base station (sub)system) for use in a radio access network (RAN) (or cellular network), the radio access network entity being configured to: obtain (for example, receive) paging data from a core network entity (for example, a Serving GPRS Support Node, SGSN, or a Mobility Management Entity, MME), wherein the paging data comprises: a paging message for broadcast to a terminal (for example, a user equipment device, UE, or a machine-to-machine, M2M, device) and at least one of: a repetition number that is indicative the number of times the paging message has been retransmitted (or communicated or recommunicated) to the radio access network (or cellular network) without a positive confirmation having been obtained by the core network; and/or an indication of the importance of the paging message; and select a radio interface paging message encoding scheme based at least in part on the repetition number and/or the indication of the importance of the paging message.

The radio access network entity may be further configured to output the paging message using the selected encoding scheme for broadcast to the terminal. Outputting the paging message may comprise broadcasting it where the radio access network entity has the means to broadcast paging messages, or communicating it to a separate entity in the RAN or cellular network that can broadcast the paging message.

The repetition number may be indicative of the number of times the paging message has been communicated to any radio access network entity within the RAN. For example, it may be the first time that the paging message has been communicated to the radio access network entity in the RAN, with the paging message having previously been communicated a number of times to at least one other radio access network entity in the RAN. In this way, the repetition number may indicate the number of times the paging message should have been broadcast to the terminal by the RAN, regardless of which radio access network entity performed the broadcasting. Alternatively, the repetition number may be indicative of the number of times the paging message has been communicated to the radio access network entity. As explained earlier, the repetition number counts the number of communication/transmission or recommunication/retransmission events from the core network entity to the radio access network entity, rather than the number of paging messages sent in each event.

The indication of the importance of the paging message may, for example, indicate that it is of low importance, for example for a routine ping of a door sensor, or it may indicate that it is of a high importance, for example trying to track a stolen high value car. The indication of the importance may take any form that is suitable to communicate the level of importance to the radio access network entity.

The indication of the importance of the paging message may indicate the importance of the mobile terminated event to which the paging message relates.

The radio access network entity may be further configured to: obtain (for example, receive) from the core network entity a paging cancelation message to cancel repeated paging in the radio access network (or cellular network). Any pending paging message(s) for the terminal, or repeated paging of the terminal, may be cancelled in this way.

The radio access network entity may be further configured to: after receipt of the paging cancelation message, allow resources on a radio interface paging channel to be used for purposes other than broadcast of the paging message to the terminal. For example, the Radio Interface Paging Channel may allow the resources to be used for some useful purpose if a paging cancellation message (cancelling repeated page transmission) is received in the midst of repeated transmissions.

The radio access network entity may be further configured to obtain (for example, receive) the paging data from the core network entity using GSM/GPRS standards and/or GSM/GPRS architecture and/or GSM/GPRS protocols. The radio access network entity may be further configured to obtain (for example, receive) the paging data from the core network entity via a Gb interface.

The radio access network entity may be further configured to obtain (for example, receive) the paging data from the core network entity using LTE standards and/or LTE architecture and/or LTE protocols. The radio access network entity may be further configured to obtain (for example, receive) the paging data from the core network entity via an S1 interface.

The present disclosure also provides a radio access network entity (for example, an e NodeB, or a Node B, or a base station (sub)system) for use in a radio access network (RAN) (or cellular network), the radio access network entity comprising: a data module configured to obtain (for example, receive) paging data from a core network entity (for example, a Serving GPRS Support Node, SGSN, or a Mobility Management Entity, MME), wherein the paging data comprises: a paging message for broadcast to a terminal (for example, a user equipment device, UE, or a machine-to-machine, M2M, device) and at least one of: a repetition number that is indicative the number of times the paging message has been retransmitted (or communicated or recommunicated) to the radio access network (or cellular network) without a positive confirmation having been obtained by the core network; and/or an indication of the importance of the paging message; and a selection module configured to select a radio interface paging message encoding scheme based at least in part on the repetition number and/or the indication of the importance of the paging message.

The present disclosure also provides a method for broadcasting a paging message to a terminal, the method comprising: a core network entity (for example, a Serving GPRS Support Node, SGSN, or a Mobility Management Entity, MME) communicating paging data to a radio access network entity (for example, an e NodeB, or a Node B, or a base station (sub)system), wherein the paging data comprises: a paging message for broadcast to a terminal (for example, a user equipment device, UE, or a machine-to-machine, M2M, device) and at least one of: a repetition number that is indicative the number of times the paging message has been retransmitted (or communicated or recommunicated) to the radio access network (or cellular network) without the core network having obtained a positive confirmation that indicates that the paging message has been received by the terminal; and/or an indication of the importance of the paging message; and the radio access network entity outputting the paging message for broadcast to the terminal.

The method may further comprise: after the terminal has received the paging message, communicating the positive confirmation to the core network entity. The positive confirmation may take any suitable form to indicate that the terminal has received the paging message. It may be communicated to the core network entity by any suitable means, for example by signalling via the cell on which the terminal is camped.

The method may further comprise: the core network entity intermittently re-communicating the paging data to the radio access network entity until the positive confirmation has been obtained by the core network entity.

The core network entity may obtain the positive confirmation by any suitable means, for example, retrieving it from a location such as a radio access network entity in the radio access network (or cellular network) (which may be the same entity that broadcast the paging message, or a different entity in the radio access network), or receiving it from the terminal by signalling via the cell that it is camped on.

Intermittently re-communicating the paging data may be periodically re-communicating the paging data, wherein periodic means at equal, or substantially equal, intervals of time (for example, every 10 ms, or every 200 ms, or every 2 seconds, or every 5 seconds, etc). Alternatively, intermittently re-communicating the paging data may be re-communicating the paging data at intervals of time, wherein the interval of time between each re-communication may be the same or different.

The indication of the importance of the paging message may indicate the importance of the mobile terminated event to which the paging message relates.

The method may further comprise: if a positive confirmation is obtained by the core network entity, communicating a paging cancelation message to the radio access network entity.

The method may further comprise: if a positive confirmation is obtained by the core network entity, allowing resources on a radio interface paging channel in the radio access network (or cellular network) to be used for purposes other than the broadcast of the paging message to the terminal.

Communication between the core network entity and the radio access network (or cellular network) may use GSM/GPRS standards and/or GSM/GPRS architecture and/or GSM/GPRS protocols. An interface between the core network entity and the radio access network (or cellular network) may comprise a Gb interface. The core network entity may comprise a Serving GPRS Support Node.

Communication between the core network entity and the radio access network (or cellular network) may uses LTE standards and/or LTE architecture and/or LTE protocols. An interface between the core network entity and the radio access network (or cellular network) may comprise an S1 interface. The core network entity may comprise a Mobility Management Entity.

The present disclosure also provides a system comprising: a core network entity (for example, a Serving GPRS Support Node, SGSN, or a Mobility Management Entity, MME); and a radio access network entity (for example, an e NodeB, or a Node B, or a base station system) configured to interface with the core network entity; wherein the system is configured to perform any of the above described method steps.

The system may further comprise at least one terminal (for example, a user equipment device, UE, or a machine-to-machine, M2M, device) configured to interface with the radio access network entity. The system may comprise a plurality of radio access network entities in a radio access network (RAN) (or cellular network).

The present disclosure also provides a core network entity (for example, a Serving GPRS Support Node, SGSN, or a Mobility Management Entity, MME) for interfacing with a radio access network entity (for example, an e NodeB, or a Node B, or a base station (sub)system), the core network entity being configured to: communicate paging data to the radio access network entity, the paging data comprising a paging message to be broadcast to a terminal (for example, a user equipment device, UE, or a machine-to-machine, M2M, device) and a cell ID for identifying the most recent cell that the terminal was known to be in.

The core network entity may be configured to communicate the paging data by any suitable means, for example by transmission or signalling, either directly or via any one or more intermediate entities.

The cell ID may take any form suitable for identifying to the radio access network entity the last known cell of the terminal.

Even with highly mobile terminals, it may be likely that a large proportion of the time the terminal will not have moved cell. Therefore, by communicating the last known cell of the terminal to the radio access network entity, the radio access network entity may target that cell, resulting in a reduction in radio and core network load.

The core network entity may be further configured to: maintain a record of the most recent cell that the terminal was known to be in; and set the cell ID based on the record of the most recent cell that the terminal was known to be in.

The core network entity may be further configured to: obtain (for example, receive) a positive confirmation that indicates that a paging message has been received by the terminal; and update the record of the most recent cell that the terminal was known to be in based on the positive confirmation.

The core network entity may obtain the positive confirmation by any suitable means, for example, retrieving it from a location such as a radio access network entity in the radio access network (or cellular network) (which may be the same entity that broadcast the paging message, or a different entity in the radio access network), or receiving it from the terminal by signalling via the cell that it is camped on.

The core network entity may be further configured to communicate the paging data to the radio access network entity using GSM/GPRS standards and/or GSM/GPRS architecture and/or GSM/GPRS protocols. The core network entity may comprise a Serving GPRS Support Node. The core network entity may be further configured to communicate the paging data to the radio access network entity via a Gb interface.

The core network entity may be further configured to communicate the paging data to the radio access network entity using LTE standards and/or LTE protocols and/or LTE architecture. The core network entity may comprise a Mobility Management Entity (MME). The core network entity may be further configured to communicate the paging data to the radio access network entity via an S1 interface.

The present disclosure also provides a core network entity (for example, a Serving GPRS Support Node, SGSN, or a Mobility Management Entity, MME) for interfacing with a radio access network entity (for example, an e NodeB, or a Node B, or a base station (sub)system), the core network entity comprising a communication module configured to communicate paging data to the radio access network entity, the paging data comprising a paging message to be broadcast to a terminal (for example, a user equipment device, UE, or a machine-to-machine, M2M, device) and a cell ID for identifying the most recent cell that the terminal was known to be in.

The present disclosure also provides a radio access network entity for use in a radio access network (RAN) (or cellular network), the radio access network entity (for example, an e NodeB, or a Node B, or a base station (sub)system) being configured to: obtain (for example, receive) paging data from a core network entity (for example, a Serving GPRS Support Node, SGSN, or a Mobility Management Entity, MME), the paging data comprising a paging message to be broadcast to a terminal (for example, a user equipment device, UE, or a machine-to-machine, M2M, device) and a cell ID for identifying the most recent cell that the terminal was known to be in, and outputting the paging message for broadcast to the terminal via at least the cell identified by the cell ID.

The radio access network entity may be configured to output the paging message by, for example, broadcasting it where the radio access network entity has the means to broadcast paging messages, or communicating it to a separate entity in the RAN that can broadcast the paging message.

The cell ID may take any form suitable for identifying to the radio access network entity the last known cell of the terminal.

Even with highly mobile terminals, it may be likely that a large proportion of the time the terminal will not have moved cell. Therefore, by targeting the cell that the terminal was known to be in, radio and core network load may consequently be reduced.

The radio access network entity may be further configured to obtain (for example, receive) the paging data from the core network entity using GSM/GPRS standards and/or GSM/GPRS protocols and/or GSM/GPRS architecture. The radio access network entity may be further configured to obtain (for example, receive) the paging data from the core network entity via a Gb interface.

The radio access network entity may be further configured to obtain the paging data from the core network entity using LTE standards and/or LTE architecture and/or LTE protocols. The radio access network entity may be further configured to obtain (for example, receive) the paging data from the core network entity via an S1 interface.

The present disclosure also provides a radio access network entity for use in a radio access network (RAN) (or cellular network), the radio access network entity (for example, an e NodeB, or a Node B, or a base station (sub)system) comprising a data module configured to obtain (for example, receive) paging data from a core network entity (for example, a Serving GPRS Support Node, SGSN, or a Mobility Management Entity, MME), the paging data comprising a paging message to be broadcast to a terminal (for example, a user equipment device, UE, or a machine-to-machine, M2M, device) and a cell ID for identifying the most recent cell that the terminal was known to be in; and a paging module configured to output the paging message for broadcast to the terminal via at least the cell identified by the cell ID.

The present disclosure also provides a method for broadcasting a paging message to a terminal (for example, a user equipment device, UE, or a machine-to-machine, M2M, device), the method comprising: a core network entity (for example, a Serving GPRS Support Node, SGSN, or a Mobility Management Entity, MME) communicating paging data to a radio access network entity (for example, an e NodeB, or a Node B, or a base station system), wherein the paging data comprises a paging message for broadcast to the terminal and a cell ID for identifying the most recent cell that the terminal was known to be in; and the radio access network entity outputting the paging message for broadcast to the terminal via at least the cell identified by the cell ID.

The radio access network entity may be configured to output the paging message by, for example, broadcasting it where the radio access network entity has the means to broadcast paging messages, or communicating it to a separate entity in the RAN that can broadcast the paging message.

The cell ID may take any form suitable for identifying to the radio access network entity the last known cell of the terminal.

Even with highly mobile terminals, it may be likely that a large proportion of the time the terminal will not have moved cell. Therefore, by targeting the cell that the terminal was known to be in, radio and core network load may consequently be reduced.

The method may further comprise: maintaining a record of the most recent cell that the terminal was known to be in; and setting the cell ID based at least in part on the record of the most recent cell that the terminal was known to be in.

The record of the most recent cell may be kept by the core network entity, or by any other entity that any interface with the core network entity.

The method may further comprise: after the terminal has received a paging message, communicating a positive confirmation to the core network entity that indicates that the paging message has been received by the terminal; and updating the record of the most recent cell that the terminal was known to be in based on the positive confirmation.

The core network entity may update the record of the most recent cell, or any other suitable entity may update the record.

Communicating the positive confirmation may take place by any suitable means. For example, the terminal may communicate the positive confirmation to the core network entity by signalling via the cell on which it is camped.

Communication between the core network entity and the radio access network (or cellular network) may use GSM/GPRS standards and/or GSM/GPRS protocols and/or GSM/GPRS architecture. An interface between the core network entity and the radio access network (or cellular network) may comprise a Gb interface. The core network entity may comprise a Serving GPRS Support Node.

Communication between the core network entity and the radio access network (or cellular network) may use LTE standards and/or LTE protocols and/or LTE architecture. An interface between the core network entity and the radio access network (or cellular network) may comprise an S1 interface. The core network entity may comprise a Mobility Management Entity (MME).

The present disclosure further provides a system comprising: a core network entity (for example, a Serving GPRS Support Node, SGSN, or a Mobility Management Entity, MME); and a radio access network entity (for example, an e NodeB, or a Node B, or a base station (sub)system) configured to interface with the core network entity; wherein the system is configured to perform the method steps described above.

The system may further comprise at least one terminal (for example, a user equipment device, UE, or a machine-to-machine, M2M, device) configured to interface with the radio access network entity. The system may comprise a plurality of radio access network entities in a radio access network (RAN) (or cellular network).

The present disclosure also provides a method of implementing soft paging area boundaries, the method comprising configuring a cell to belong to multiple paging areas (for example, routing areas).

The present disclosure also provides a radio access network entity configured to support at least one cell that belongs to a plurality of paging areas.

The present disclosure also provides a system for implementing soft paging area boundaries, the system comprising a core network entity (for example, a Serving GPRS Support Node, SGSN, or a Mobility Management Entity, MME); and a radio access network entity (for example, an e NodeB, or a Node B, or a base station (sub)system) configured to interface with the core network entity, wherein the system is configured to such that at least one cell in the radio access network (or cellular network) belongs to a plurality of paging areas.

The above disclosed system, method and radio access network entity may be configured to implement NB-IoT standards/protocols/architecture, or any other suitable standards/protocols/architecture.

A cell may belong to a plurality of paging areas in accordance with the 2^{nd} Generation Japanese PDC system.

The present disclosure also provides a method of implementing soft paging area boundaries by using a Tracking Area List.

The present disclosure also provides a radio access network entity configured to implement soft paging area boundaries, at least by using a Tracking Area List.

The present disclosure also provides a system for implementing soft paging area boundaries, the system comprising a core network entity (for example, a Serving GPRS Support Node, SGSN, or a Mobility Management Entity, MME); and a radio access network entity (for example, an e NodeB, or a Node B, or a base station (sub)system) configured to interface with the core network entity, wherein the system is configured to such a Tracking Area List is used in implementing the soft paging area boundaries.

The above disclosed system, method and radio access network entity may be configured to implement NB-IoT standards/protocols/architecture, or any other suitable standards/protocols/architecture.

A Tracking Area List may be used in accordance with LTE standards.

The present disclosure also provides a method of implementing soft paging area boundaries, wherein a cell can belong to a plurality of different registration areas. The cell may belong to up to 8 different registration areas.

The method may use the UTRAN Registration Area concept, or similar, such that the cell can belong to up to 8 different URAs.

The present disclosure also provides a radio access network entity configured to implement soft paging areas boundaries by supporting a cell belonging to a plurality of different registration areas. The cell may belong to up to 8 different registration areas. The radio access network entity may be configured to use the UTRAN Registration Area concept, or similar, such that the cell can belong to up to 8 different URAs.

The present disclosure also provides a system for implementing soft paging area boundaries, the system comprising a core network entity (for example, a Serving GPRS Support Node, SGSN, or a Mobility Management Entity, MME); and a radio access network entity (for example, an e NodeB, or a Node B, or a base station (sub)system) configured to interface with the core network entity, wherein the system is configured to support a cell belong to a plurality of different registration areas. The cell may belong to up to 8 different registration areas. The system may be configured to use the UTRAN Registration Area concept, or similar, such that the cell can belong to up to 8 different URAs.

The above disclosed system, method and radio access network entity may be configured to implement NB-IoT standards/protocols/architecture, or any other suitable standards/protocols/architecture.

The paging message identified in the above described aspects of the disclosure may comprise any type of data of any size that is intended to be communicated to a terminal by broadcast on a RAN or cellular network. The paging message may comprise arbitrary data for a ‘ping’ of the terminal, or mobile terminating (MT) data, such as an SMS message, or any other type of data.

The terminal in the above described aspects of the disclosure may be a mobile terminal.

Whilst this disclosure generally describes applications in GSM/GPRS and LTE architectures and protocols, it will be appreciated that it may be applied to any other architectures and protocols, for example the narrow band IoT (NB-IoT) standards, architectures and protocols.

An M2M device may be any device wherein at least part of the device communications operations are autonomous (i.e., do not require user or operator interaction). For example, an M2M device may be a smart meter that provides utility meter readings autonomously to utility providers via a communications interface, or a vehicle control module that autonomously provides sensor readings to a vehicle servicing company and/or receives vehicle configuration updates or vehicle services control (such as remote unlocking of the vehicle) via a communications interface, or a street lighting control unit that may be managed or updated by a device management server via a communications interface etc. In any event, an M2M device may be a relatively simple device, or a more complex device, which may be controlled, or managed, or provide data to a different entity server, or through which a different entity may provide a service, via a communications interface without requiring any user or operator input.

Each of the radio access network entities described in the above may be a single entity (for example an e NodeB, or a Node B, or a base station (sub)system) or may be part of a single entity. Alternatively, their functionality may be divided between two or more different entities that may interface with one another in order to carry out the functionality described in the above. The two or more different entities may be co-located, or located in different geographic locations.

Likewise, each of the core network entities described in the above may be a single entity (for example an SGSN or MME) or may be part of a single entity. Alternatively, their functionality may be divided between two or more different entities that may interface with one another in order to carry out the functionality described in the above. The two or more different entities may be co-located, or located in different geographic locations.

The present disclosure also provides software, for example a set of computer executable instructions, configured to cause at least one electric processor (for example, a microprocessor) to perform or execute any of the method steps described in the above. The present disclosure also provides a non-transitory computer readable medium for storing the software.

Any of the core network entities and/or radio access network entities described in the above may comprise memory and a processor. The processor may be configured to execute any of the method steps described in the above. The memory may be configured to store software, or a set of computer executable instructions, configured to cause the processor to execute any of the method steps described in the above. Additionally, or alternatively, the core network entities and/or radio access network entities may comprise any sort of logic, or programmable logic. The logic, or programmable logic, may be configured to perform any of the method steps described in the above.

It will be appreciated that any combinations of at least part of any of the above disclosed aspects, and any combinations of at least part of any of the below described features and aspects, are encompassed by the present disclosure.

### BRIEF DESCRIPTION OF THE DRAWINGS

Aspects of the present disclosure are described, by way of example only, with reference to the following drawings, in which:

FIG. 1 shows an example system comprising a core network entity, radio access network entities and a terminal;

FIG. 2 shows an example flow diagram representing method steps in accordance with an implementation of an aspect of the present disclosure;

FIG. 3 shows an example flow diagram representing method steps in accordance with an implementation of a further aspect of the present disclosure;

FIG. 4 shows an example flow diagram representing method steps in accordance with an implementation of a further aspect of the present disclosure;

It should be noted that the drawings are highly schematic, are illustrated for simplicity and are not necessarily drawn to scale. Like features are provided with the same reference numerals.

Acronyms

IoT—Internet of Things

M2M—Machine-to-Machine

CIot—Cellular Internet of Things

GERAN—GSM Radio Access Network

BSS—Base Station System

3GPP—3^{rd} Generation Partnership Project

RA—Routing Area

TA—Tracking Area

TAI—Tracking Area Identifier

UE—User Equipment

SGSN—Serving GPRS Support Node

LA—Location Area

LAI—Location Area Identifier

RAC—Routing Area Code

LAC—Location Area Code

CI—Cell Identifier

UTRAN—UMTS Terrestrial Radio Access Network

E-UTRAN—Evolved Universal Terrestrial Radio Access

RAI—Routing Area Identification

RAU—Routing Area Update

TMSI—Temporary Mobile Subscriber Identity

RAI—Routing Area Identifier

RAN—Radio Access Network

MT—Mobile Terminating

IE—Information Element

PS—Packet Switch

CS—Circuit Switch

PLMN—Public Land Mobile Network

BSC—Base Station Controller

CN—Core Network

TAI—Tracking Area Identity

UMTS—Universal Mobile Telecommunications System

LTE—Long-Term Evolution

EMM—EPS Mobility Management

MME—Mobility Management Entity

RACH—Random Access Channel

AGCH—Absolute Grant Channel

URA—UTRAN Registration Area

MM—Mobility Management

SI—System Information

RR—Radio Resource

MCC—Mobile Country Code

MNC—Mobile Network Code

AS—Access Stratum

NAS—Non-access Stratum

### DESCRIPTION

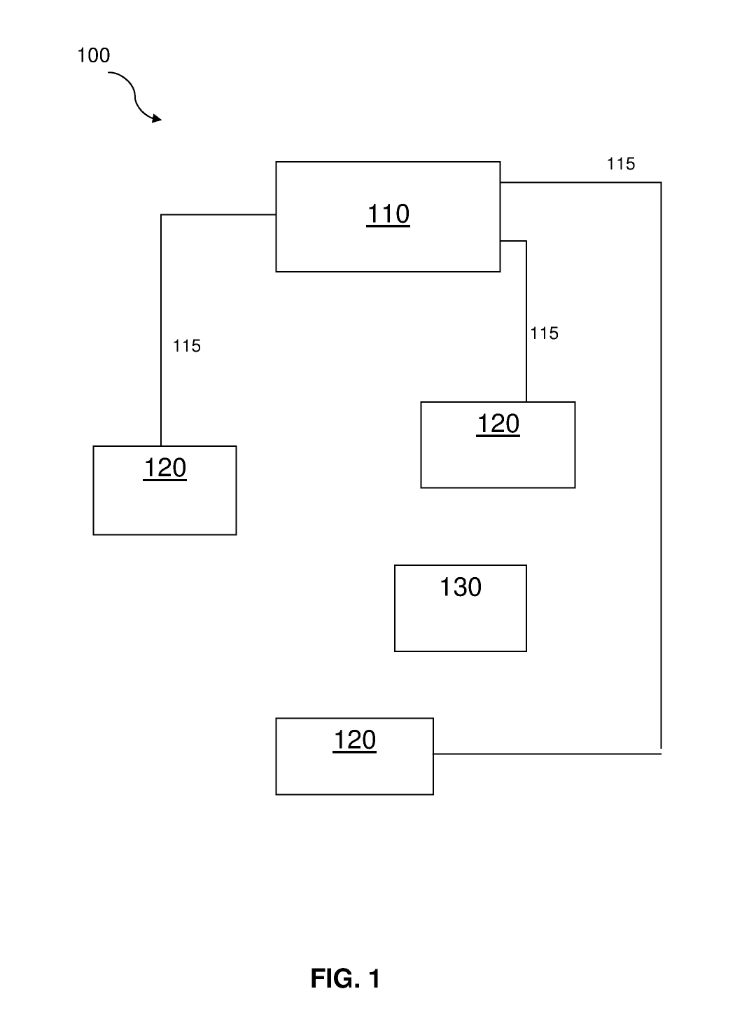

FIG. 1 shows a highly schematic, example system 100. The system 100 comprises a core network entity 110, radio access network entities 120 that are all part of the same radio access network (or cellular network), interfaces 115 between the core network entity 110 and each of the radio access network entities 120, and a terminal 130.Where the system utilises a GSM/GPRS architecture, the core network entity 110 may comprise a Serving GPRS Support Node (SGSN) and the interfaces 115 may comprise Gb interfaces. Where the system utilises an LTE architecture, the core network entity 110 may comprise a Mobility Management Entity (MME) and the interfaces 115 may comprise S1 interfaces.

The radio access network entities 120 may each comprise a base station (sub)system (BSS), a Node B, an e Node B, or any other suitable entities to interface with the core network and output data for broadcast to the terminal 130. The terminal 130 may be a user equipment device, UE, or a machine-to-machine, M2M, device. It will be appreciated that the terminal 130 may be static or mobile.

The system 100 represented in FIG. 1 is not intended to be limiting. For example, the system 100 may comprise any number of core network entities 110, any number of radio access network entities 120, each of which interface with at least one core network entity 110, any number of different radio access networks (RANs) or cellular networks and any number of terminals 130. The interfaces 115 may directly connect each of the radio access network entities 120 to at least one core network entity 110, or may indirectly couple each of the radio access network entities 120 to at least one core network entity 110, for example via any number of network routing elements, etc. Furthermore, whilst specific examples of GSM/GPRS and LTE architectures are given, it will be appreciated that the system 100 and the various methods, processes described wherein may utilise any other suitable standards/protocols/architectures, for example ND-IoT.

Each of the core network entity 110 and the radio access network entities 120 may comprise memory and at least one processor configured to perform or execute any one or more of the method or process steps defined or described in the present application. Each of the core network entity 110 and the radio access network entities 120 may comprise software, for example a set of computer executable instructions, configured to cause the at least one processor to execute one or more steps of any of the methods or processes defined or described in the present application. The software may be stored in the memory or in any other non-transitory computer readable medium.

Any or all of the following methods, processes and implementations may be applied, separately or in combination, to the system 100 represented in FIG. 1.

3 Need for ‘Soft’ Paging Area Boundaries

GSM's PS and CS domains have “hard” paging area boundaries: the cells are in only one RAI, and the mobile is allocated only one RAI.

This means that the cells on the edge of a Routing Area are subject to much more intense signalling load (e.g. on RACH and AGCH) than cells in the middle of a RA.

Operators normally want the freedom to move RA boundaries after sites have been installed. Hence the cells on the RA boundary are the same size (e.g. geographically, or, number of users, or, “number of erlangs”) as those in the centre of the RA.

Thus the capacity of the 2G system tends to be determined by the traffic AND signalling load on the cells on the RA boundary.

The “hard paging area boundary” issue was addressed by the 2^{nd} Generation Japanese PDC system (in which a cell can be configured to belong to multiple paging areas); acknowledged in the design of UMTS (with the UTRAN Registration Area concept in which a cell can belong to up to 8 different URAs); and solved in LTE with the “Tracking Area List” concept.

All of these concepts aim to avoid the UE ping-ponging back and forth between paging areas by e.g. allocating the UE into a paging area which is ‘centred’ on the UE's current location.

Proposal 1: it is proposed that CIot adopt a concept that avoids hard paging area boundaries.

Note: hard paging area boundaries are still anticipated at PLMN boundaries and (for some UEs) at network sharing boundaries

4 Stationary Devices and Mobility

Cellular operators add and remove cells from their network. Operators also reconfigure the cell's RAI, e.g. when they re-parent a cell from one BSC (or SGSN) to another BSC (or SGSN).

Environmental changes happen: e.g. buildings get built or knocked down; trees grow; the seasons change and leaves fall/grow; rainstorms occur; lorries park outside your house. Hence, to the core network, even stationary devices can seem to be “mobile” and change RA.

5 Coverage Extension for Paging

For the extended coverage cases, there is a general interest in “extending range by data repetition”. This works well for the contents of the System Information messages as their content rarely changes.

However, the contents of the paging messages should always be changing (and this is particularly the case if a paging message can carry multiple identities).

Movement into and out of poor coverage areas can occur much more frequently than movement between cells or between RAs. Signalling to the network at each ‘coverage level’ change would impose a huge signalling load and UE battery drain.

Paging typically occurs across multiple base stations. With the current Gb/Iu/S1 based architectures, a base station does not know whether a mobile has responded to paging on another base station in the paging area, or, whether the mobile is in poor coverage (and hence “higher energy” page transmission (=repetitions) is desired).

With multi-site paging areas, paging responses will be detected by a more central node. It is this central node that can determine whether the UE has not responded and hence a page retransmission is needed. However, retransmissions from the core network will be separated by more than the DRX paging interval and hence, at the radio level, the UE cannot do any practical “combining” of the RF power across them.

Hence coverage extension via paging retransmission will be most effective (in both range extension and minimising wasted page messages in the wrong cell) if it is based on a single cell or single site.

Proposal 2: the system should aim (but not mandate) that mobiles that require “paging repetition” are allocated to a single cell's or single base station site's “paging area”.

UEs that move in and out of poor coverage, and, which also move between cells are a problem. For these core network based retransmission will be needed. In order to assist the RAN in determining what “energy” to put into a page, the CN could indicate the repetition number, and, provide an indication of the importance of the MT event (e.g. routine ping of a door sensor vs trying to track a stolen high value car).

Proposal 3: the CN-RAN interface could be enhanced to indicate to the CIot RAN whether the page is a first page or 2^{nd} or 3^{rd} page for that UE, and, to indicate the importance of the MT event. This would permit the RAN to make an appropriate choice of its paging message encoding scheme.

Proposal 4: (if proposal 3 is adopted) the CN-RAN interface should be enhanced to allow the SGSN to cancel paging in the RAN, e.g. in the case that the UE has responded on one base station but “99 other base stations” are in the midst of “16 page repetitions”.

Proposal 5: (building on proposals 3 and 4) the Radio Interface Paging Channel should allow the resources to be used for some useful purpose if a “repeated page transmission” is cancelled by the core network in the midst of its repeated transmissions.

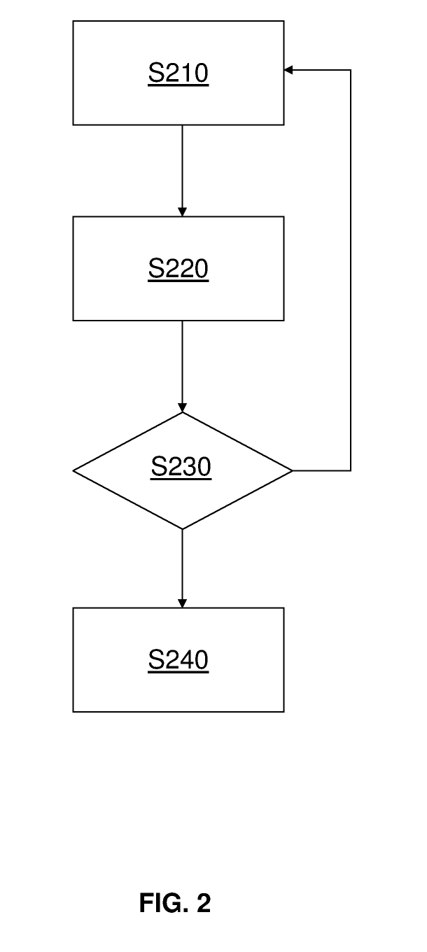

FIG. 2 of the drawings shows, by way of example only, a representation of method steps in accordance with one implementation of this aspect of the present disclosure.

In Step S210, the core network entity 110 communicates paging data to at least one of the radio access network entities 120, the paging data comprising a paging message for broadcast to the terminal 130 and at least one of a repetition number the indicates the number of times the paging message has been retransmitted, or communicated, to the radio access network and/or an indication of the importance of the paging message.

In Step S220, the at least one of the radio access network entities 120 outputs the passaging message for broadcast to the terminal 130.

In Step S230, the core network entity 110 may determine whether or not a positive confirmation has been received. If it has, the method may proceed to step S240, where a paging cancelation message is communicated to the radio access entity 120. If it has not, the method may return to Step S210, where the paging message is retransmitted or recommunicated to the radio access network entity 120.

6 Selection of Correct Paging Areas per Coverage Type

It is suggested that Base Station is configured such that the Radio Interface broadcasts three RAIs per cell.

Whenever a UE transmits to a cell, the Base Station assesses the coverage level (normal, poor, or extended). In the Base Station, each coverage level is associated with one of the broadcast RAIs. When the UE's information (e.g. LLC frame for Gb interface or EMM message for S1 interface) is sent to the core network, the RAI associated with that coverage level is inserted into the UL Unitdata message (Gb interface) or Initial UE message (S1 interface).

Thus when the UE performs a RA Update Request (or Attach Request), the SGSN will receive (from the BSS) the “new RAI” that corresponds to the UE's coverage level. An unmodified SGSN will then allocate this RAI back to the UE in the RAU Accept message.

By this means an unmodified SGSN can be used to assign RAIs corresponding to the correct coverage level.

If using an MME and the S1 interface, some extra logic is needed to ensure that the MME does not construct a TAI List that contains extra TAIs. This logic could be achieved by a coding within the TAI, or, preferably by an additional parameter from the RAN to indicate that the TAI List should be constrained to a single TAI.

Proposal 6 The Base Station broadcasts multiple RAIs; has the capability to associate each RAI with a different coverage class; and indicates the RAI of the UE's coverage class to the Core Network in the existing Gb/S1 interface signalling.

Proposal 7 the RAN-CN interface signalling is extended so that the RAN can request the Core Network to construct a TAI List (or RAI list) that only contains one TAI (or RAI).
Note: the concept of a base station broadcasting multiple area IDs is one used by UMTS's release 99 URA concept. The significant difference here is that the UE only sees RAs, not a mix of RAs, URAs and cells, and hence has just one MM state machine and a reduced set of state transitions

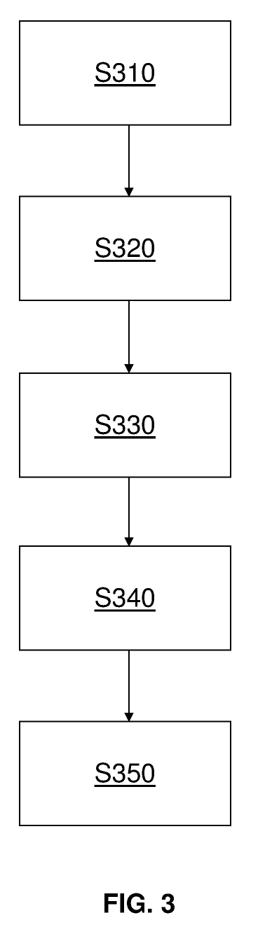

FIG. 3 of the drawings shows, by way of example only, a representation of method steps in accordance with one implementation of this aspect of the present disclosure.

In Step S310, a radio access network entity 120 may receive or otherwise obtain a transmission from the terminal 110. The transmission may be a paging area update request.

In Step S320, the radio access network entity 120 determines a coverage level for the terminal 110 in a cell in the cellular network, or radio access network, of which the radio access network entity 120 is a part. In Step S330, the radio access network entity 120 identifies a paging area corresponding to the determined coverage level for the terminal 130. In Step S340, the radio access network entity 120 allocates the identified paging area to the terminal, which may comprise communicating the identified paging area (the “new RAI”) to the core network entity 110.

In Step S350, the core network entity 110 may communicate the allocated identified paging area to the terminal 130, for example in an RAU accept message.

8 Signal Strength Hysteresis at Routing Area Boundary

To minimise core network and RACH/AGCH load, the UE could apply some extra signal strength hysteresis at an RA boundary (more specifically, only at an RA boundary that will lead to an RA update).

GSM and GPRS already have such a concept and the “CRH” value is broadcast in System Information.

However, this does require the UE to be able to read the RAI(s) from the neighbouring cell's System Information before selecting the new cell. UMTS and LTE do not support such capability—and this has some impacts on “the blocking of frequencies for 300 seconds” (see TSs 36.304 and 25.304).

Proposal 8 GERAN 1 should be consulted about the feasibility of the UE reading the neighbour cell System Information BEFORE performing cell change.

9 Modified SGSN to Support “Routing Area LIST” Concept

The Release 8 Tracking Area List concept provides “soft TA boundaries”. However features such as CS FallBack (that need TAI List boundaries to not cross the ‘hard’ 2G/3G location area boundaries) are likely to have restricted MME development in the area of “intelligent TAI list allocation”.

In Release 8, the UE provides its “last visited TAI” to the MME in the TAU Request in order to permit the MME to easily construct a TAI list of the “current TAI plus the last visited TAI”.

It would seem fairly straightforward to extend the TS 24.008 RAU request to carry the “last visited RA” and for the SGSN to allocate a “primary RAI” and a list of “additional RAIs” to the device. The primary RAI is the legacy one that is linked to the P-TMSI to form the UE's globally unique temporary ID. The UE uses the primary RAI and additional RAIs to form an “RAI list”: the UE then only does a RA Update when the UE enters a cell that does not broadcast any RAI in the “RAI list”.

Data analytics of cell movement/connected mode transmissions can be used to optimise RAI list allocation as the Gb interface probes and/or SGSN can track UE identity, Cell ID and current RAI.

The use of an RAI list concept in CIot would enable the Base Stations to be configured into relatively small (e.g. 7 site) Routeing Areas and the SGSN to allocate an appropriate RAI list based on analysis of the UE's movement and its (UE terminating) traffic. This should enable significant radio interface paging capacity savings.

Proposal 9: for a Gb interface based CIot system, TS 24.008 should be extended to support an RAI List concept.
Note: these TS 24.008 RAI List extensions could be applied to 2G/3G PS domain (if combined with an indication that the UE supports it). However, without co-ordination across the MSC and SGSN (or the use of NMO1=Gs interface) the benefits would mainly be limited to PS domain-only devices (as the number of RAs per Location Area is frequently low—although it could still be useful when distinct 2G and 3G RA Codes are used in a common 2G/3G Location Area).

As these “7 site” RAIs might be relatively small (e.g. compared to typical LTE TAs), to minimise RAU signalling from highly mobile UEs, it seems reasonable to permit the RAI List to contain more than LTE's maximum of 16 TAs per TAI list. The impact of a longer TAI list would seem to be on the UE's NAS memory—which sits relatively high up in the protocol stack, and so would not seem to be a serious concern.

Proposal 10: (building on proposal 9) the maximum number of RAIs in the RAI list should be 128.

10 Paging in Last Known Cell (or BSS) and Adjacent Cells.

As described by NTT DOCOMO in S2-141884, paging in the last known cell can be used to reduce radio and core network load at the expense of latency if the device has moved. Alternative mechanisms in which the Base Station passes the paging message onto adjacent Base Station sites “over an ×2 like interface” could also be used (as described in the first part of Vodafone's S2-144273).

Nomadic functions “e.g. tracking you bicycle” may still benefit as 90% of the time that is still in the last known cell.

With a BSS serving many sites, addition of last known Cell ID to the Gb interface paging message could assist the BSS.

Proposal 11: for a CIot that uses a BSS serving many sites (e.g. one based on “GSM evolution”), addition of last known Cell ID to the Gb interface paging message could assist the BSS.

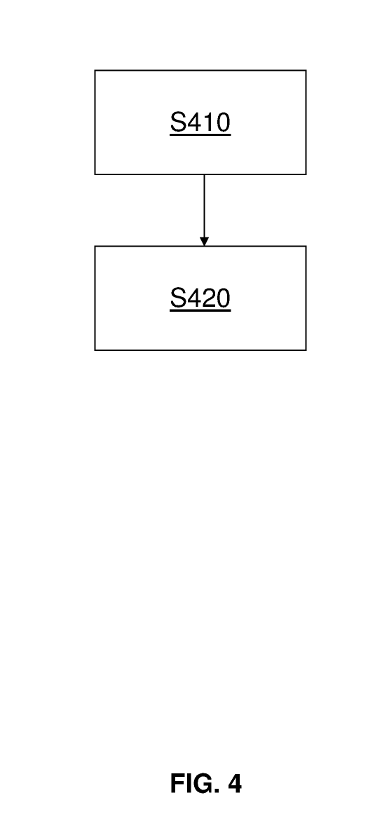

FIG. 4 of the drawings shows, by way of example only, a representation of method steps in accordance with one implementation of this aspect of the present disclosure.

In Step S410, the core network entity 110 communicates paging data to at least one of the radio access network entities 120, the paging data comprising at least a paging message for broadcast to the terminal 130 and a cell ID identifying the most recent cell that the terminal 130 was known to be in.

In Step S420, the radio access network entity 120 outputs the paging message for broadcast to the terminal via the cell identified by the cell ID.

The core network entity 110 may keep a record of the most recent cell that the terminal was known to be in and set the cell ID based on the record. Furthermore, in response to receiving a positive confirmation that indicates that the paging message has been received by the terminal (wherein the positive confirmation may also indicate the cell in which the message was received), the core network entity 110 may update the record.

11 Reuse of GSM NAS Software in CIot Device

To simplify the specification process of CIot, there has been a good focus on minimising (towards zero) the impact on the 3GPP Core Network nodes.

As a consequence it could be possible to reuse an existing “NAS software” implementation in the UE. However, the sourcing company believes that there are substantial software reductions that should be possible for CIot in the UE (e.g. no CS domain; no ‘Combined CS/PS Mobility Management’).

Despite the likely re-coding of the UE's NAS software, maintenance of the NAS/AS separation and the primitive based interface between them in the UE may have advantages e.g. in terms of avoiding omissions in designs.

One example of the reuse would be in the way that the Access Stratum in the UE separately presents the Cell ID and RAI to the Non-Access Stratum layer.

Some changes to the UE NAS are needed to handle a Base Station Broadcasting multiple RAIs. However, this should not be significantly more complex than e.g. the presentation of multiple PLMN IDs from AS to NAS for network sharing.

12 Minimising System Information Broadcasts

Proposal 6, above implies that the base station could transmit 3 RAIs, e.g:

a) one RAI for the sector (useful to minimise overall paging channel load for UEs in poor coverage in that sector)

b) one RAI common across the three sectors of the site (useful if a poor coverage UE is on a sector boundary)

c) one RAI for a cluster of perhaps 7 sites.

While the LAI part (=MCC+MNC+LAC) of the RAIs (RAI=LAI+RAC) is likely to be common, this still requires the broadcast transmission of an extra couple of 1 byte Routeing Area Codes.

One mechanism to reduce the broadcast information would be for the UE (and base station) to treat the Cell ID as a way to create an RAI. i.e. the System Information broadcast transmits one field that “by the RR protocol” the UE's AS layer treats as both a Cell ID and a RAI. The Cell ID and RAI are passed across the UE's AS/NAS boundary as independent parameters and handled by the TS 24.008 (and other higher layer) software according to current rules. This would minimise the SI broadcast needed for (a).

For (b) the above concept could be extended such that 4 RA Codes are used by a site: one RA code (e.g. ending 00) means “the site” or more explicitly “all RA Codes with these 6 leading digits”; the other 3 RA codes indicate the sectors.

For a concrete example:

A Base Station Broadcasts the following information:
MCC, MNC=234-15 (BCD)
LAC=6789 (hex)
RAC=ab(hex)

CI=cdef (hex)

Then the UE's Access Stratum presents the following information to its Non-Access Stratum:

Cell Global ID=235-15-6789-cdef (because of its CS domain heritage, RAC is not part of the CGI)

First RAI=234-15-6789-ab (this can be imagined as the traditional RAI)

Second RAI=234-15-ab-cdef (this is the per sector/“cell” RAI)

Third RAI=235-15-ab-cde-1100 (the last two digits of the CI are set to zero. This is the “site RAI”).

The UE's NAS then checks the contents of the RAI (List) received in the last RAU Accept message against all THREE of these RAIs. If there is any match, then the UE does not need to do an RA update.

Proposal 12: techniques such as those described above are used to minimise the amount of System Information broadcast while maintaining the ability for one base station to be a member of multiple Routing Areas.

13 EXAMPLE of Overall Concept with Multiple RAIs per Cell and a RAI list in RAU Accept

This is an example. With these tools, other solutions are possible.

Imagine a pure hexagonal grid of 3 sectored sites:
a) Moving UEs are allocated a List of several RAIs in the RAU Accept message. Each of these RAIs is a set of 7 base station sites. SGSN level analysis determines the size of the RAI list.
b) For devices in very poor coverage, the Base Station allocates the UE to an RAI that is ONLY broadcast by that cell (=sector). This ‘allocation’ is done by including only that RAI into the Gb Uplink Unitdata message that carries the RAU Request.
c) For devices in poor (but not very poor) coverage, or which the base station knows to be on an intra-site sector boundary, the base station allocates the UE to an RAI that is specific to all sectors of that site.
Note: while b and c are close to UMTS connected mode's Cell PCH and URA PCH concepts, by describing them as Routeing Areas, the UE's mobility model can be kept to have a small number of states (and hence few different state transitions)

d) For UEs that appear to the SGSN to be low mobility (and/or for which “applications” wish to track), the SGSN allocates a small List of RAIs.
e) For more mobile UEs (and/or which have a ‘small amount of UE terminating traffic’) a large RAI List is allocated.
f) For devices with a large amount of UE terminating traffic, the SGSN allocates a smaller List of RAIs.
g) The base station analyses the RAI received in the Gb paging message. If it corresponds to the single sector RAI then the base station knows that the UE is likely to be in poor coverage and hence it should perform local retransmissions of the paging message in a manner that aids ‘combining’ of the retransmissions in the UE.

For ‘CIot launch’ no SGSN upgrades are needed, but, later optimisations are possible by enhancing the SGSN.

Inter-operability Testing of the UE's ability to handle RAI Lists in RAU Accept can be done on test equipment.

14 Summary

This combined approach of RAI List and (about) 3 RAIs per cell appears to allow operators and implementers to minimise paging load and (radio and core) signalling load for a range of different mobility characteristics, coverage classes, and terminating traffic requirements while permitting the reuse of existing Core Network equipment.

While the above discussion has focussed on Gb mode and potentially on the “clean slate” CIot approach, most of it seems applicable to an S1 interface based system and/or an “Evolved GERAN” CIot approach.

15 Way Forward

Delegates are invited to consult with their colleagues in other Working Groups (e.g. SA 2 and CT 1), however, very few changes outside of GERAN's scope are actually proposed, so, the author believes that this work can be initially treated within TSG-GERAN.

It is requested that the above discussion and proposals are reviewed, and, if possible some agreements on the numbered proposals made.

1. A method for allocating a paging area for a terminal in a cellular network, the method comprising the steps of:
determining a coverage level for the terminal in a cell in the cellular network;
identifying a paging area corresponding to the determined coverage level for the terminal; and
allocating the identified paging area to the terminal.

2. The method of claim 1, further comprising:
receiving, at a radio access network entity, a transmission from the terminal, wherein the step of determining the coverage level for the terminal in the cell is based at least in part on the received transmission.

3. The method of claim 2, wherein the received transmission from the terminal is a paging area update request.

4. The method of any preceding claim, wherein allocating the identified paging area to the terminal comprises transmitting the allocated paging area to the core network.

5. The method of claim 4, further comprising:
transmitting a request that the core network constructs a paging area listing comprising a single paging area.

6. The method of either claim 4 or claim 5, wherein the allocated paging area is transmitted to the core network using GSM standards.

7. The method of claim 6, wherein the core network comprises a Serving GPRS Support Node.

8. The method of claim either 6 or claim 7, wherein the allocated paging area is transmitted to the core network via a Gb interface.

9. The method of claim 8, wherein the allocated paging area is transmitted to the core network via the Gb interface as at least part of a UL Unitdata message.

10. The method of any of claims 1 to 5, wherein the allocated paging area is transmitted to the core network using LTE standards.

11. The method of claim 10, wherein the core network comprises a Mobility Management Entity.

12. The method of either claim 10 or claim 11, wherein the allocated paging area is transmitted to the core network via an S1 interface.

13. The method of claim 12, wherein the allocated paging area is transmitted to the core network via the S1 interface as at least part of an MME message.

14. The method of any preceding claim, wherein the paging area comprises at least one of a location area, a routing area and/or a tracking area.

15. The method of any preceding claim, wherein the coverage level for the terminal comprises at least one of a normal coverage level, a poor coverage level, and/or an extended coverage level.

16. A network entity configured to perform the method of any of claims 1 to 15.

17. The network entity of claim 16, further configured to broadcast a plurality of paging area identifiers per cell.

18. A base station comprising the network entity of either claim 16 or claim 17.

19. A terminal configured to identify a paging area in a cellular network using at least a cell identifier.

20. The terminal of claim 19, further configured to:
receive a cell identifier; and
identify the paging area by determining a paging area identifier based at least in part on the cell identifier.

21. The terminal of claim 20, wherein the paging area is a routing area.

22. The terminal of claim 21 configured to:
receive at least one of a mobile country code, a mobile network code, a location area code, a location area identifier and/or a routing area code; and
determine the paging area identifier based at least in part on the cell identifier and at least one of the received mobile country code, mobile network code, location area code, location area identifier and/or routing area code.

23. The terminal of any of claims 19 to 22, further configured to:
modify at least part of the cell identifier; and
determine the paging area identifier based at least in part on the modified cell identifier

24. The terminal of any of claims 19 to 23, further configured to:
check the identified paging area against a paging area list; and
if the paging area list does not comprise the identified paging area, transmit a paging area update request.

25. A radio access network entity for support of a cell that is a member of a plurality of paging areas, wherein at least one of the paging areas is identifiable using at least an identifier of the cell.

26. The radio access network entity of claim 25, configured to:
broadcast the identifier of the cell; wherein at least one of the plurality of paging areas is uniquely identifiable using at least the identifier of the cell.

27. The radio access network entity of claim 26, further configured to:
broadcast at least one of a mobile country code, a mobile network code, a location area code, a location area identifier and/or a routing area code, wherein at least one of the plurality of paging areas is uniquely identifiable using the identifier of the cell and at least one of the mobile country code, the mobile network code, the location area code, the location area identifier and/or the routing area code.

28. The radio access network entity of claim 27, wherein each of the plurality of paging areas is uniquely identifiable using different combinations of the identifier of the cell, the mobile country code, the mobile network code, the location area code, the location area identifier and/or the routing area code.

29. A system comprising:
a radio access network entity for supporting a cell that is a member of a plurality of paging areas; and
a terminal configured to identify at least one of the paging areas using at least an identifier of the cell.

30. The system of claim 29, wherein the terminal is further configured to uniquely identify at least one of the paging areas using at least an identifier of the cell combined with at least one of a mobile country code, a mobile network code, a location area code, a location area identifier and/or a routing area code.

31. A method for identifying a first paging area of a plurality of paging areas of which a cell is a member, the method comprising;
identifying the first paging are using at least an identifier of the cell.

32. The method of claim 31 comprising:
identifying the first paging area using at least the identifier of the cell combined with at least one of a mobile country code, a mobile network code, a location area code, a location area identifier and/or a routing area code.

33. The method of claim 32 comprising:
identifying a second paging area using at least the identifier of the cell combined with at least one of a mobile country code, a mobile network code, a location area code, a location area identifier and/or a routing area code, wherein the combination used to identify the second paging area is different to the combination used to identify the first paging area.

34. A core network entity for interfacing with a radio access network entity, the core network entity being configured to:
communicate paging data to the radio access network entity, the paging data comprising a paging message to be broadcast to a terminal;
obtain a positive confirmation that indicates that the paging message has been received by the terminal; and
intermittently re-communicate the paging data to the radio access network entity until a positive confirmation has been obtained.

35. The core network entity of claim 34, wherein the paging data further comprises:
a repetition number that is indicative of the number of times the paging message has been retransmitted to the radio access network.

36. The core network entity of either claim 34 or claim 35, wherein the paging data further comprises:
an indication of the importance of the paging message.

37. The core network entity of claim 36, wherein the indication of the importance of the paging message indicates the importance of the mobile terminated event to which the paging message relates.

38. The core network entity of any of claims 34 to 37, further configured to:
if a positive response is obtained, communicate a paging cancelation message to the radio access network entity.

39. The core network entity of any of claims 34 to 38, where in the radio access network entity is a plurality of radio access network entities in a radio access network.

40. The core network entity of any of claims 34 to 39, further configured to communicate the paging data to the radio access network entity using GSM/GPRS standards.

41. The core network entity of claim 40 comprising a Serving GPRS Support Node.

42. The core network entity of either claim 40 or 41, further configured to communicate the paging data to the radio access network entity via a Gb interface.

43. The core network entity of any of claims 34 to 39, further configured to communicate the paging data to the radio access network entity using LTE standards.

44. The core network entity of claim 43 comprising a Mobility Management Entity.

45. The core network entity of either claim 43 or 44, further configured to communicate the paging data to the radio access network entity via an S1 interface.

46. A radio access network entity for use in a radio access network, the radio access network entity being configured to:
obtain paging data from a core network entity, wherein the paging data comprises:
a paging message for broadcast to a terminal and at least one of:
a repetition number that is indicative the number of times the paging message has been retransmitted by the core network; and/or
an indication of the importance of the paging message; p1 select a radio interface paging message encoding scheme based at least in part on the repetition number and/or the indication of the importance of the paging message.

47. The radio access network entity of claim 46, wherein the indication of the importance of the paging message indicates the importance of the mobile terminated event to which the paging message relates.

48. The radio access network entity of either claim 46 or claim 47, further configured to:
obtain from the core network entity a paging cancelation message to cancel repeated paging in the radio access network.

49. The radio access network entity of claim 48, further configured to:
after receipt of the paging cancelation message, allow resources on a radio interface paging channel to be used for purposes other than broadcast of the paging message to the terminal.

50. The radio access network entity of any of claims 46 to 49, further configured to obtain the paging data from the core network entity using GSM/GPRS standards.

51. The radio access network entity of claim 50, further configured to obtain the paging data from the core network entity via a Gb interface.

52. The radio access network entity of any of claims 46 to 49, further configured to obtain the paging data from the core network entity using LTE standards.

53. The radio access network entity of claim 52, further configured to obtain the paging data from the core network entity via an S1 interface.

54. A method for broadcasting a paging message to a terminal, the method comprising:
a core network entity communicating paging data to a radio access network entity, wherein the paging data comprises:
a paging message for broadcast to a terminal and at least one of:
a repetition number that is indicative the number of times the paging message has been retransmitted to the radio access network; and/or
an indication of the importance of the paging message; and
the radio access network entity outputting the paging message for broadcast to the terminal.

55. The method of claim 54, further comprising:
after the terminal has received the paging message, communicating the positive confirmation to the core network entity.

56. The method of either claim 54 or 55, further comprising:
the core network entity intermittently re-communicating the paging data to the radio access network entity until the positive confirmation has been obtained.

57. The method of any of claims 54 to 56, wherein the indication of the importance of the paging message indicates the importance of the mobile terminated event to which the paging message relates.

58. The method of any of claims 54 to 57, further comprising:
if a positive confirmation is obtained by the core network entity, communicating a repeated paging cancelation message to the radio access network entity.

59. The method of any of claims 54 to 58, further comprising:
if a positive confirmation is obtained by the core network entity, allowing resources on a radio interface paging channel in the radio access network to be used for purposes other than the broadcast of the paging message to the terminal.

60. The method of any of claims 54 to 59, wherein communication between the core network entity and the radio access network uses GSM/GPRS standards.

61. The method of claim 60, wherein an interface between the core network entity and the radio access network comprises a Gb interface.

62. The method of either claim 60 or claim 61, wherein the core network entity comprises a Serving GPRS Support Node.

63. The method of any of claims 54 to 59, wherein communication between the core network entity and the radio access network uses LTE standards.

64. The method of claim 63, wherein an interface between the core network entity and the radio access network comprises an S1 interface.

65. The method of either claim 63 or claim 64, wherein the core network entity comprises a Mobility Management Entity.

66. A system comprising:
a core network entity; and
a radio access network entity configured to interface with the core network entity; wherein
the system is configured to perform the method of any of claims 54 to 65.

67. A core network entity for interfacing with a radio access network entity, the core network entity being configured to:
communicate paging data to the radio access network entity, the paging data comprising a paging message to be broadcast to a terminal and a cell ID for identifying the most recent cell that the terminal was known to be in.

68. The core network entity of claim 67, further configured to:
maintain a record of the most recent cell that the terminal was known to be in; and
set the cell ID based on the record of the most recent cell that the terminal was known to be in.

69. The core network entity of claim 68, further configured to:
obtain a positive confirmation that indicates that a paging message has been received by the terminal; and
update the record of the most recent cell that the terminal was known to be in based on the positive confirmation.

70. The core network entity of any of claims 67-69, further configured to communicate the paging data to the radio access network entity using GSM/GPRS standards.

71. The core network entity of claim 70 comprising a Serving GPRS Support Node.

72. The core network entity of either claim 70 or 71, further configured to communicate the paging data to the radio access network entity via a Gb interface.

73. The core network entity of any of claims 67-69, further configured to communicate the paging data to the radio access network entity using LTE standards.

74. The core network entity of claim 73 comprising a Mobility Management Entity.

75. The core network entity of either claim 73 or 74, further configured to communicate the paging data to the radio access network entity via an S1 interface.

76. A radio access network entity for use in a radio access network, the radio access network entity being configured to:
obtain paging data from a core network entity, the paging data comprising a paging message to be broadcast to a terminal and a cell ID for identifying the most recent cell that the terminal was known to be in, and
outputting the paging message for broadcast to the terminal via the cell identified by the cell ID.

77. The radio access network entity of claim 76, further configured to obtain the paging data from the core network entity using GSM/GPRS standards.

78. The radio access network entity of claim 77, further configured to obtain the paging data from the core network entity via a Gb interface.

79. The radio access network entity of claim 76, further configured to obtain the paging data from the core network entity using LTE standards.

80. The radio access network entity of claim 79, further configured to obtain the paging data from the core network entity via an S1 interface.

81. A method for broadcasting a paging message to a terminal, the method comprising:
a core network entity communicating paging data to a radio access network entity, wherein the paging data comprises a paging message for broadcast to a terminal and a cell ID for identifying the most recent cell that the terminal was known to be in
the radio access network entity outputting the paging message for broadcast to the terminal via the cell identified by the cell ID.

82. The method of claim 81, further comprising:
maintaining a record of the most recent cell that the terminal was known to be in; and
setting the cell ID based on the record of the most recent cell that the terminal was known to be in.

83. The method of claim 82, further comprising: p1 after the terminal has received a paging message, communicating a positive confirmation to the core network entity that indicates that the paging message has been received by the terminal; and
updating the record of the most recent cell that the terminal was known to be in based on the positive confirmation.

84. The method of any of claims 81 to 83, wherein communication between the core network entity and the radio access network uses GSM/GPRS standards.

85. The method of claim 84, wherein an interface between the core network entity and the radio access network comprises a Gb interface.

86. The method of either claim 84 or claim 85, wherein the core network entity comprises a Serving GPRS Support Node.

87. The method of any of claims 81 to 83, wherein communication between the core network entity and the radio access network uses LTE standards.

88. The method of claim 87, wherein an interface between the core network entity and the radio access network comprises an S1 interface.

89. The method of either claim 87 or claim 88, wherein the core network entity comprises a Mobility Management Entity.

90. A system comprising:
a core network entity; and
a radio access network entity configured to interface with the core network entity; wherein
the system is configured to perform the method of any of claims 81 to 89.
